(19) United States
(12) Patent Application Publication
(10) Pub. No.: US 2025/0327975 A1
(43) Pub. Date: Oct. 23, 2025

(54) Optical Fiber Module and Its Manufacturing Method

(71) Applicant: Nippon Telegraph and Telephone Corporation, Tokyo (JP)

(72) Inventors: Satomi Katayose, Musashino-shi, Tokyo (JP); Junji Sakamoto, Musashino-shi, Tokyo (JP); Yuji Fujiwara, Musashino-shi, Tokyo (JP)

(21) Appl. No.: 18/870,087

(22) PCT Filed: May 30, 2022
(86) PCT No.: PCT/JP2022/021962

§ 371 Date: Nov. 27, 2024

(51) Int. Cl. G02B 6/255; G02B 6/30

(52) U.S. Cl. CPC G02B 6/2551; G02B 6/30

(57) ABSTRACT

The optical fiber module according to the present invention is an optical fiber module including a planar light wave circuit and an optical fiber optically coupled with the planar light wave circuit, in which an optical waveguide including a core and a clad is formed on a substrate in the planar light wave circuit, a conductive thin film is provided on an inclined surface formed between an end surface of the substrate spliced with the optical fiber and a back surface of the substrate, and the optical fiber is fusion-spliced with the planar light wave circuit.

### TECHNICAL FIELD

The present invention relates to an optical fiber module and a method for manufacturing the same, and more particularly to an optical fiber module formed by fusion-splicing a quartz-based planar light wave circuit and an optical fiber.

### BACKGROUND ART

Examples of a method of connecting a quartz-based planar light wave circuit (PLC) and an optical fiber includes methods such as fixing with a UV curable adhesive and fusion bonding with a laser, and in particular, fusion splicing is used in a quartz-based PLC for visible wavelength and high output, since the UV curable adhesive is changed in quality by light of visible wavelength and high output, which increases the connection loss.

In such fusion splicing, the heat capacities of the quartz-based PLC and the optical fiber are relatively largely different from each other, and the use of a silicon substrate for the quartz-based PLC causes the silicon substrate to act as a heat slinger, so that the fiber spliced portion of the quartz-based PLC may not melt or only the optical fiber may excessively melt and be deformed.

For this reason, for example, Patent Literature 1 describes that a part of a silicon substrate of a module is removed to suppress heat dissipation. As a result, the heat capacities of the quartz-based PLC and the optical fiber can be matched. Moreover, it is known that heating for fusion bonding is performed by external heating (Patent Literature 2).

### CITATION LIST

### Patent Literature

Patent Literature 1: JP H2-251916 A

Patent Literature 2: JP H8-75949 A

Patent Literature 3: WO 2014/196444 A

Patent Literature 4: JP 2006-269984 A

### SUMMARY OF INVENTION

### Technical Problem

However, the method of removing a part of the substrate requires a photolithography/etching technique to remove the substrate, and there are problems that the steps are relatively complicated, and time and manufacturing cost are required. Moreover, external heating for heating the quartz-based PLC also has a problem of consuming a large amount of electric power.

An object of the present invention is to provide an optical fiber module capable of removing a substrate more simply in a short time and suppressing power consumption for heating for melting in manufacturing an optical fiber module including a quartz-based PLC and an optical fiber fusion-bonded with the quartz-based PLC, and a method for manufacturing the optical fiber module.

### Solution to Problem

An aspect of an optical module according to the present invention is an optical fiber module including a planar light wave circuit and an optical fiber optically coupled with the planar light wave circuit, in which an optical waveguide including a core and a clad is formed on a substrate in the planar light wave circuit, a conductive thin film is provided on an inclined surface formed between an end surface of the substrate spliced with the optical fiber and a back surface of the substrate, and the optical fiber is fusion-spliced with the planar light wave circuit.

### Advantageous Effects of Invention

According to the present invention, it is possible to remove a substrate more simply in a short time in manufacturing an optical fiber module including a quartz-based PLC and an optical fiber fusion-bonded with the quartz-based PLC, and to suppress power consumption for heating for melting.

### BRIEF DESCRIPTION OF DRAWINGS

FIG. 1(a) is a diagram illustrating an optical module according to the present invention. FIG. 1(b) is a diagram of an example illustrating an optical module according to the present invention.

FIG. 2 is a diagram illustrating an optical module according to Example 1 of the present invention.

FIG. 3(a) is a flowchart illustrating steps for manufacturing an optical module according to Example 1 in respective stages. FIG. 3(b) is a diagram illustrating steps for manufacturing an optical module 20 according to Example 1 in respective stages.

FIG. 4 is a diagram illustrating an optical module according to Example 1 of the present invention.

### DESCRIPTION OF EMBODIMENTS

Hereinafter, embodiments of the present invention will be described with reference to the drawings. Note that portions having the same functions are denoted by the same reference numerals in the drawings, and repetitious description is omitted.

### First Embodiment

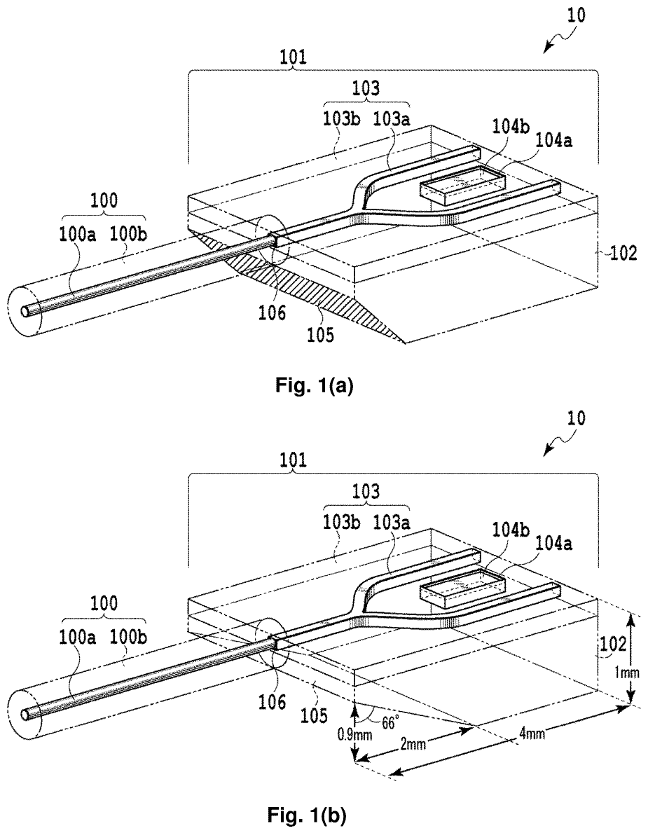

FIG. 1(a) is a perspective view schematically illustrating an optical module 10 according to a first embodiment of the present invention. The optical module 10 includes an optical fiber 100 including at least one core, and a planar light wave circuit 101, and the optical fiber 100 and the planar light wave circuit 101 are spliced at a fusion bonding portion 106. Here, the planar light wave circuit 101 includes a substrate 102, an optical waveguide 103 including a core 103a and a clad 103b on the substrate 102, a light shielding groove 104a formed by removing a part of the clad 103b, a light shielding material 104b filling the light shielding groove 104a, and a conductive thin film 105 provided on an inclined surface formed between an end surface spliced with the optical fiber 100 and a back surface of the substrate. Here, the optical fiber 100 includes a core portion 100a and a clad portion 100b. Moreover, the light shielding groove 104a and the light shielding material 104b filling the light shielding groove are provided to perform termination processing of excess optical power.

The inclined surface of the substrate 102 is formed by mechanical polishing, and the inclined surface exists from the spliced end surface constituting the fusion bonding portion 106 of the planar light wave circuit 101. In addition, by providing the conductive thin film 105 on the inclined surface, the conductive thin film 105 can be brought close to the fusion bonding portion 106.

For example, in a planar light wave circuit having a substrate thickness of 1 mm and a substrate length (in fiber longitudinal direction) of 4 mm as illustrated in FIG. 1(b), the polishing angle may be set to approximately 66° for polishing only a region having a substrate thickness of 0.9 mm and a substrate length of 2 mm (½ of the total substrate length) in order to secure the mechanical strength of the planar light wave circuit, particularly the mechanical strength of a region where the light shielding groove is formed.

The core 103a and the clad 103b are made of a quartz-based material, the substrate 102 is made of a quartz-based material or silicon, and the light shielding material 104b is made of a light-shielding resin. The conductive thin film 105 is a thin film containing particles of conductors such as metal and carbon, or semiconductor particles, or a thin film containing ink and paste- like dispersoid in which conductors or semiconductors are dispersed, and can be instantaneously raised in temperature by microwave irradiation (Patent Literature 3).

As described above, removal of the silicon substrate 102, that is, removal of the substrate corresponding to formation of the inclined surface can be performed by machining (polishing). As a result, it is possible to remove the substrate more simply in a short time in order to reduce the heat capacity difference between the planar light wave circuit and the optical fiber in the process of fusion-splicing the planar light wave circuit and the optical fiber.

oreover, since the conductive thin film 105 is formed on the inclined surface of the substrate 102, heating for fusion bonding can be achieved using microwave heating. As a result, unlike external heating such as a conventional heater, the conductive thin film 105 itself generates heat, so that low-power, local, and rapid heating can be performed, and power consumption for fusion bonding can be suppressed. Furthermore, by heating the spliced end surfaces of the planar light wave circuit 101 and the optical fiber 100 by microwave irradiation and simultaneously heating and fusion-bonding the optical fiber 100 by a laser beam, only the fusion bonding portion 106 is selectively heated, the entire planar light wave circuit 101 does not reach a high temperature of several 100° C. or higher, heat dissipation is suppressed, and volatilization and change in quality of the light shielding material 104b can be suppressed.

Although the conductive thin film 105 is formed on the entire inclined surface of the substrate 102 in the present embodiment, a conductive thin film may be formed only in a part of the inclined surface of the substrate 102 near the fusion bonding portion.

According to the present invention, it is possible to manufacture a planar light wave circuit by a simple machining technique without requiring a photolithography/etching technique for substrate removal for reducing the heat capacity, and it is possible to selectively heat only a fusion bonding portion by forming a conductive thin film on a substrate portion of the planar light wave circuit and locally and rapidly heating the conductive thin film by microwave irradiation.

In the present embodiment, since a portion of the substrate is formed by mechanical polishing, it is unnecessary to form a groove on the substrate by patterning. Therefore, simplification, time shortening, and cost reduction can be achieved.

### Second Embodiment

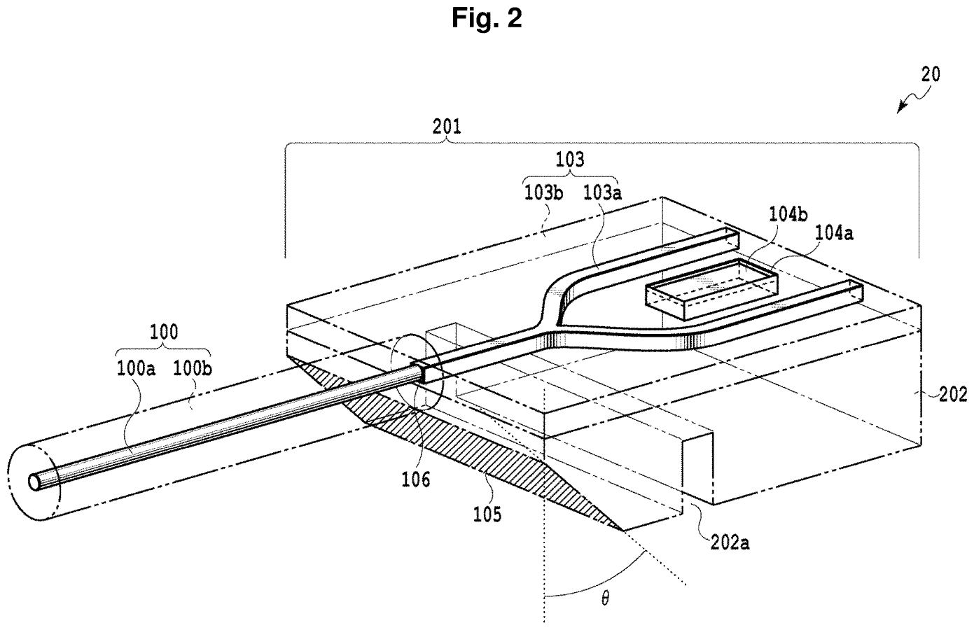

FIG. 2 is a perspective view illustrating an optical module 20 according to a second embodiment of the present invention. By forming a heat insulating groove 202a nearer to a side spliced with the optical fiber 100 than the light shielding groove 104a by removing a part of the substrate 102 in the optical module 10 in FIG. 1(a), the optical module 20 in which heat dissipation is suppressed and the optical fiber 100 is fusion-bonded can be manufactured by a laser beam with lower output.

FIG. 2 illustrates a planar light wave circuit 201 in which a substrate 202 is made of silicon and a core 103a and a clad 103b are made of quartz-based materials, and an optical fiber 100. The substrate 202 of the planar light wave circuit 201 is provided with a light shielding groove 104a formed by removing the clad 103b, the light shielding groove 104a is filled with a light shielding material 104b, and a portion of the substrate on the side of an end surface spliced with the optical fiber 100 is obliquely polished, and a conductive thin film 105 is formed on an obliquely polished surface (an inclined surface). Moreover, on a back surface of the planar light wave circuit 201 (a back surface of the substrate 202), the heat insulating groove 202a is formed nearer to a side spliced with the optical fiber 100 than the light shielding groove 104a by removing the substrate. In the present example, a material obtained by mixing carbon fine particles into a resin is used as the light shielding material 104b, and a thin film containing carbon particles is used as the conductive thin film 105. Furthermore, in order to enable fusion bonding by a low-power laser, the heat insulating groove 202a is formed on the substrate 202.

According to the present invention, it is possible to remove a substrate more simply in a short time in manufacturing an optical fiber module including a quartz-based PLC and an optical fiber fusion-bonded with the quartz-based PLC, and to suppress power consumption for heating for melting.

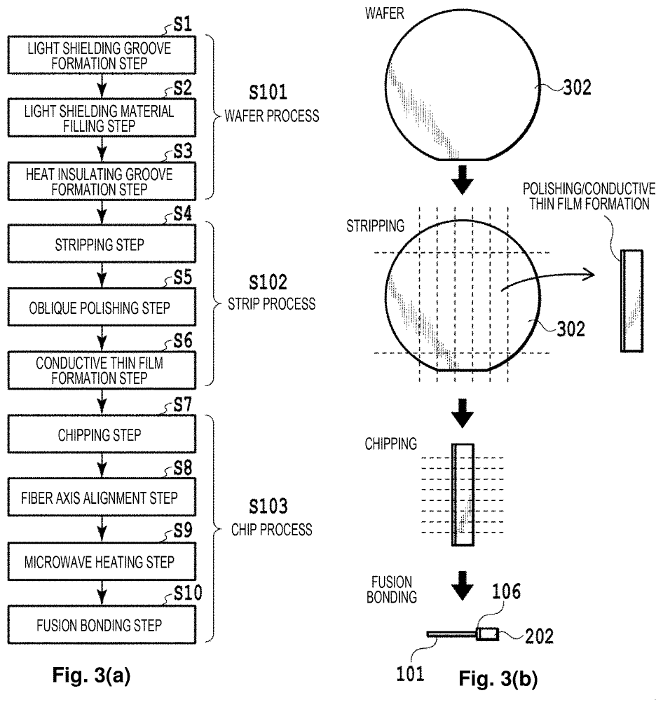

FIG. 3(a) is a flowchart illustrating steps for manufacturing the optical module 20 according to Example 1 in respective stages. FIG. 3(b) is a diagram illustrating steps for manufacturing the optical module 20 according to Example 1 in respective stages.

The wafer process S101 will be described. The planar light wave circuit 101 made of a quartz-based material used in this example is manufactured by a method of sequentially forming a lower clad layer and a layer of the core 103a on a silicon wafer 302 using a photolithography/etching technique, etching the layer of the core 103a while leaving a portion to be the optical waveguide 103, and then depositing an upper clad layer. The light shielding groove 104a is also formed by a photolithography/etching technique (S1: light shielding groove formation step). Next, filling with the light shielding material 104b is performed by a microdispenser (S2: light shielding material filling step). Since the heat insulating groove 202a has a simple pattern, etching is simply performed using a mask tape without using a photolithography technique in the present example (S3: heat insulating groove formation step).

Next, the strip process S102 will be described. The silicon wafer 302 is stripped by dicing. (S4: Stripping step), an end surface for fiber splicing is polished. In the present specification, an angle formed by an end surface on the fiber splicing side (an end surface of the substrate) and the oblique polishing is referred to as a polishing angle θ. The polishing angle can be determined on the basis of a heat quantity of suppressing heat dissipation and mechanical strength required for the optical module and the planar light wave circuit. In this example, the polishing angle θ is set to 45°. As the polishing angle θ becomes larger, the effect of suppressing heat dissipation increases. The polishing angle θ may be within the range of 45° or more and less than 90° (S5: oblique polishing step). In the process of fusion-bonding the planar light wave circuit and the fiber, the heat of the fiber fusion bonding portion moves toward the substrate 102 (e.g., a silicon substrate) having high thermal conductivity. In order to suppress this movement, a portion of the substrate 102 of the planar light wave circuit 101 on the fusion bonding portion 106 side of the fiber is removed. It is assumed that about a half of the substrate immediately below the fusion bonding portion of the fiber is removed at 45° or more.

For forming the conductive thin film 105 on the polished surface, carbon is deposited using a carbon vapor deposition device (S6: conductive thin film formation step).

Subsequently, the chip process S103 will be described. The strip-shaped wafer is diced into chips to form the planar light wave circuit 101 to be used for an optical fiber module (S7: chipping step).

Thereafter, the planar light wave circuit 101 and the optical fiber 100 are fixed on a stage, and alignment is performed so as to establish optical interconnection (S8: fiber axis alignment step). The aligning method in the process of establishing optical interconnection between the planar light wave circuit 101 and the optical fiber 100 is similar to a method of fixing with a conventional UV curable adhesive and a conventional fusion bonding method.

Thereafter, the planar light wave circuit 101 is irradiated with a microwave having a wavelength of 2.45 GHz using a microwave heating device, and only the conductive thin film 105 patterned on the polished surface is selectively heated instantaneously (S9: microwave heating step). Subsequently, a laser beam is condensed on the fusion bonding portion 106 between the planar light wave circuit 101 and the optical fiber 100, so that fusion splicing is achieved (S10: fusion bonding step).

Here, in the present example in which the substrate of the planar light wave circuit 101 is made of silicon, energy absorption of microwaves occurs, since silicon is not transparent to microwaves. The absorbed energy is converted into heat to increase the temperature of the planar light wave circuit 101 around the substrate in a short time. Since volume expansion of the planar light wave circuit 101 including the substrate is caused by the temperature rise, it is conceivable that a deviation in the optical axis may be generated between the planar light wave circuit and the aligned optical fiber 100. A slight deviation (<1 μm) does not become a problem in a case where the mode field at the splicing point between the planar light wave circuit 101 and the optical fiber 100 is large, while a deviation may become a problem in a case where the mode field is small or the like. Therefore, in a case where a silicon substrate is used for the planar light wave circuit 101, a material containing metal-based particles and carbon-based particles mixed with each other (Patent Literature 3 and Patent Literature 4) may be used as the conductive thin film 105 in order to further enhance the selective heating property of microwave heating. As a result, only the conductive thin film 105 is selectively heated by microwave irradiation, a temperature rise can be suppressed even in the planar light wave circuit 101 configured using a silicon substrate, and positional deviation between the planar light wave circuit 101 and the optical fiber 100 can be suppressed.

Furthermore, although the planar light wave circuit 101 in which the layer of the optical waveguide 103 on an end surface spliced with the optical fiber 100 is vertical and the substrate portion is obliquely polished is fusion-spliced with the optical fiber 100 in which the end surface is vertical in the present embodiment, the reflection attenuation amount can be further reduced when polishing each of the layer of the optical waveguide 103 of the planar light wave circuit 101 and the optical fiber 100 obliquely at several degrees (approximately 8°) in a case where it is desired to further reduce reflection.

Filling with the light shielding material can also be performed after optical fiber fusion bonding. However, since the filling cannot be performed before the wafer process, there arise problems that the throughput is not increased, filling the light shielding groove with the light shielding material with the fiber being attached is complicated, and it takes time and space for the work. These problems can be solved by using a method according to the present embodiment.

### Third Embodiment

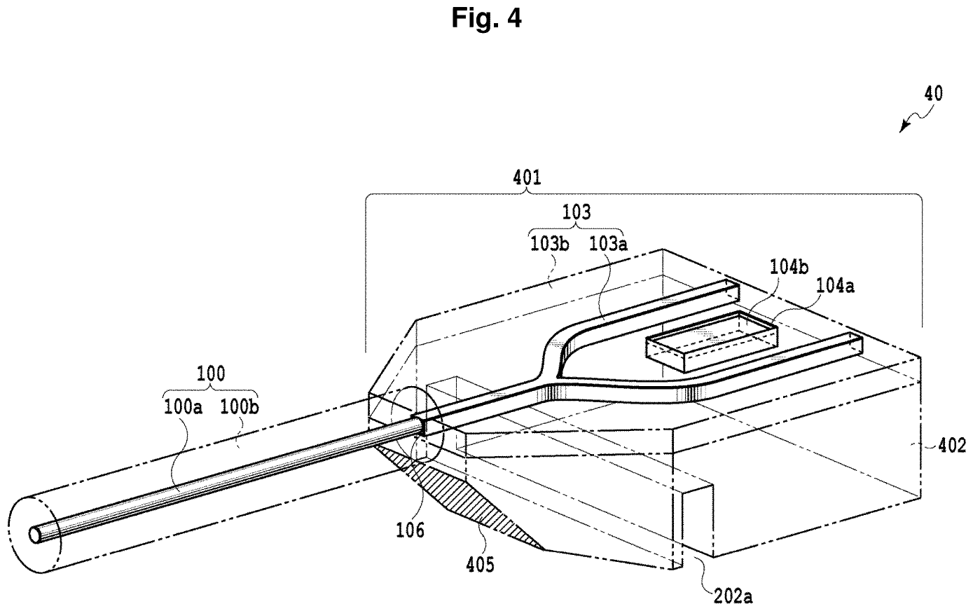

In addition, in order to further reduce the heat capacity in a planar light wave circuit 401 in FIG. 4 according to the present example, a portion of an optical fiber 100 excluding a spliced portion (a fusion bonding portion 106), an optical waveguide 103, and a light shielding groove 104a is removed by dicing or the like after being chipped so that the lateral length of an end surface of an optical module 40 on a side spliced with the optical fiber 100 is shorter than the lateral length of an end surface of the optical module 40 facing the end surface in FIG. 4, and the planar light wave circuit 401 having a conductive thin film 405 adjacent to the lower side of an end surface of the optical module 40 on the side spliced with the optical fiber 100 can be obtained. The optical module 40 can be fusion-bonded by a laser with further lower power.

According to the present invention, it is possible to remove a substrate more simply in a short time in manufacturing an optical fiber module including a quartz-based PLC and an optical fiber fusion-bonded with the quartz-based PLC, and to suppress power consumption for heating for melting.

Although a laser fusion bonding method is used for fusion bonding in the above example, the present invention is not limited thereto, and a discharge fusion bonding method can also be used. Millimeter waves may be used as an alternative to microwave heating. Furthermore, regarding an optical waveguide, although an optical fiber is spliced with a quartz-based optical waveguide formed on a silicon substrate in the above description, the present invention can also be sufficiently applied to a quartz-based optical waveguide formed on a quartz substrate. Furthermore, the present invention can be applied to fusion splicing of not only a single-core optical fiber but also a multi-core optical fiber.

1. An optical module that is an optical fiber module including a planar light wave circuit and an optical fiber optically coupled with the planar light wave circuit,
wherein an optical waveguide including a core and a clad is formed on a substrate in the planar light wave circuit,
a conductive thin film is provided on an inclined surface formed between an end surface of the substrate spliced with the optical fiber and a back surface of the substrate, and
the optical fiber is fusion-spliced with the planar light wave circuit.

2. The optical module according to claim 1, wherein a heat insulating groove is formed on the substrate in the planar light wave circuit.

3. The optical module according to claim 1, wherein the substrate is a silicon substrate or a quartz substrate, and the conductive thin film is a thin film containing particles of conductors such as metal and carbon or semiconductor particles, or a thin film containing ink and paste-like dispersoid in which conductors or semiconductors are dispersed.

4. The optical module according to claim 1, wherein a lateral length of an end surface of the optical module on a side spliced with the optical fiber is shorter than a lateral length of an end surface of the optical module facing the end surface.

5. A method for manufacturing an optical module including a planar light wave circuit and an optical fiber including at least one core optically coupled with the planar light wave circuit, the method comprising: a step of obliquely polishing a portion of a substrate of the planar light wave circuit on a side of an end surface spliced with the optical fiber; a step of patterning a conductive thin film on an obliquely polished surface; a step of heating the conductive thin film by a laser fusion bonding method or a discharge fusion bonding method; and a step of fusion-splicing the optical fiber with the planar light wave circuit.

6. The method for manufacturing an optical module according to claim 5, wherein the laser fusion bonding method is microwave irradiation or millimeter wave irradiation.

7. The method for manufacturing an optical module according to claim 5, further comprising a step of removing a part of the substrate to form a heat insulating groove in the planar light wave circuit.

8. The method for manufacturing an optical module according to claim 5, wherein an angle formed by an end surface of the substrate and oblique polishing is 45° or more and less than 90°.

9. The optical module according to claim 2, wherein the substrate is a silicon substrate or a quartz substrate, and the conductive thin film is a thin film containing particles of conductors such as metal and carbon or semiconductor particles, or a thin film containing ink and paste-like dispersoid in which conductors or semiconductors are dispersed.

10. The optical module according to claim 2, wherein a lateral length of an end surface of the optical module on a side spliced with the optical fiber is shorter than a lateral length of an end surface of the optical module facing the end surface.

11. The method for manufacturing an optical module according to claim 6, further comprising a step of removing a part of the substrate to form a heat insulating groove in the planar light wave circuit.

12. The method for manufacturing an optical module according to claim 6, wherein an angle formed by an end surface of the substrate and oblique polishing is 45° or more and less than 90°.
